(19) United States
(12) Patent Application Publication
(10) Pub. No.: US 2025/0042607 A1
(43) Pub. Date: Feb. 6, 2025

(54) LIQUID CONTAINER

(71) Applicant: FUJIFILM CORPORATION, Tokyo (JP)

(72) Inventor: Daisuke HIBE, Kanagawa (JP)

(21) Appl. No.: 18/888,162

(22) Filed: Sep. 18, 2024

Related U.S. Application Data
(63) Continuation of application No. PCT/JP2023/010396, filed on Mar. 16, 2023.

(30) Foreign Application Priority Data
Mar. 22, 2022 (JP) 2022-045777

(51) Int. Cl. B65D 17/50; B65D 17/00; B65D 17/28

(52) U.S. Cl. CPC B65D 17/502; B65D 17/02; B65D 17/404

(57) ABSTRACT

A liquid container includes: an accommodating portion that accommodates a liquid and has an opening portion at an upper end thereof, a sealing film that seals the opening portion and that is capable of being perforated by being pierced by a perforating tool; and at least one linear pressure indentation that is linear and that is formed on a surface of the sealing film, wherein, a length of at least one pressure indentation is a length equal to or greater than 50% of a length from an end portion to an end portion of the opening portion in a direction in which the pressure indentation extends.

### CROSS-REFERENCE TO RELATED APPLICATIONS

This application is a continuation of International Application No. PCT/JP2023/010396, filed on Mar. 16, 2023, which claims priority from Japanese Patent Application No. 2022-045777, filed on Mar. 22, 2022. The entire disclosure of each of the above applications is incorporated herein by reference.

### BACKGROUND

### 1. Technical Field

The technique of the present disclosure relates to a liquid container.

### 2. Description of the Related Art

JP2008-89604A discloses a configuration of a container lid for easily breaking a lid of a top opening of a container for collecting and transferring a liquid sample with a pipette blunt end and for self-resealing the lid. The container lid has a diaphragm made of an elastomer material, and the diaphragm is torn by pressing the front end of the pipette, and a nick is formed. The pipette is inserted into the container through the nick.

### SUMMARY

As described in JP2008-89604A, in a case where a sealing film for sealing a container in which a liquid is accommodated is perforated by a perforating tool such as a pipette, the liquid, which is accommodated in the container, may be scattered to the outside of the container. The reason is as follows. First, the front end of the perforating tool is pierced into the sealing film. Therefore, a through-hole having a diameter close to the diameter of the perforating tool is opened in the sealing film. Since the liquid in the container is attached to the rear surface of the sealing film, in a case where the through-hole is opened, the liquid attached to the rear surface of the sealing film encircles a gap between the through-hole and the perforating tool, and the liquid enters the gap. In a case where the diameter of the perforating tool and the diameter of the through-hole are close to each other, that is, in a case where the gap width between the perforating tool and the inner edge of the through-hole is narrow, the liquid is held to clog the gap. On the other hand, a pressure in the container also increases by inserting the perforating tool into the container, and air in the container is about to be ejected to the outside of the container from the gap between the through-hole and the perforating tool. As the insertion amount of the perforating tool increases, the internal pressure increases, and the pressure at which the air in the container is about to be ejected to the outside of the container through the gap also increases. In a case where the insertion amount of the perforating tool further increases and the pressure in the container further increases, the air in the container eventually is ejected to the outside of the container together with the liquid which clogs the gap. With such a mechanism, the liquid held in the gap between the through-hole and the perforating tool may be ejected to the outside of the container, and the liquid may be scattered around the through-hole.

An object of a technique according to the present disclosure is to suppress scattering of the liquid to the outside of the liquid container in a case of perforating the sealing film that seals the opening portion of the liquid container accommodating the liquid.

The liquid container according to an aspect of the present disclosure comprises: an accommodating portion that accommodates a liquid and has an opening portion at an upper end thereof; a sealing film that seals the opening portion and that is capable of being perforated by being pierced by a perforating tool; and at least one pressure indentation that is linear and is formed on a surface of the sealing film, in which a length of the at least one pressure indentation is a length equal to or greater than 50% of a length from an end portion to an end portion of the opening portion in a direction in which the pressure indentation extends.

In the liquid container according to the aspect of the present disclosure, the opening portion may have, in a plan view, two directions of a first direction in which a distance between inner edges is relatively long and a second direction which is orthogonal to the first direction and in which the distance is relatively short, and the length of the at least one pressure indentation may be longer than the distance along the second direction of the opening portion.

In the liquid container according to the aspect of the present disclosure, a plurality of the pressure indentations may be formed and intersect with each other at one intersection.

In the liquid container according to the aspect of the present disclosure, two pressure indentations may be formed to intersect with each other at a central point of the pressure indentations.

In the liquid container according to the aspect of the present disclosure, the pressure indentation may intersect with each other at a central point of the opening portion.

In the liquid container according to the aspect of the present disclosure, the pressure indentations may be orthogonal to each other.

In the liquid container according to the aspect of the present disclosure, a planar shape of the opening portion may be an elongated circular shape.

In the liquid container according to the aspect of the present disclosure, a plurality of the accommodating portions may be provided, and the opening portions of the accommodating portions may be arranged side by side.

In the liquid container according to the aspect of the present disclosure, the pressure indentation may be provided in each of the opening portions.

In the liquid container according to the aspect of the present disclosure, the sealing film may be made of aluminum.

According to the technique of the present disclosure, it is possible to suppress scattering of the liquid to the outside of the liquid container in a case of perforating the sealing film for sealing the opening portion of the container which accommodates the liquid.

### BRIEF DESCRIPTION OF THE DRAWINGS

FIG. 1 is a perspective view showing a cartridge as an example of a liquid container according to the present disclosure.

FIG. 2A is a cross-sectional view showing a cartridge as an example of the liquid container according to the present disclosure, and FIG. 2B is a top view thereof.

FIG. 3A is a top view showing an opening portion and pressure indentation formed in the liquid container according to the present disclosure, and FIG. 3B is a cross-sectional view taken along a line B-B of FIG. 3A.

FIG. 4A is a side view showing a state where a perforating tool is about to perforate a sealing film of a liquid container according to a comparative example, FIG. 4B is a side view showing a state where the perforating tool is being pressed against the sealing film, FIG. 4C is a side view showing a state where the sealing film has been perforated, FIG. 4D is a side view showing a state where the perforating tool is being inserted into the liquid container, FIG. 4E is a side view showing a state where the perforating tool has been pulled out from the liquid container, and FIG. 4F is a cross-sectional view taken along a line F-F in FIG. 4C.

FIG. 5 is a side view showing an example of a situation of scattering of the liquid in a case where the perforating tool perforates the sealing film of the liquid container according to the comparative example.

FIG. 6A is a side view showing a state where a perforating tool is about to perforate a sealing film of the liquid container according to the present disclosure, FIG. 6B is a side view showing a state where the perforating tool is being pressed against the sealing film, FIG. 6C is a side view showing a state where the sealing film has been perforated, FIG. 6D is a side view showing a state where the perforating tool is being inserted into the liquid container, and FIG. 6E is a side view showing a state where the perforating tool has been pulled out from the liquid container.

FIG. 7A is a perspective view showing a state where the perforating tool is inserted into the liquid container according to the present disclosure, and FIG. 7B is a plan view showing a shape of a through-hole.

FIG. 8A is a top view showing a modification example of the liquid container according to the first embodiment of the present disclosure, and FIG. 8B is a top view showing the other modification example.

### DESCRIPTION OF EMBODIMENTS

Hereinafter, a liquid container according to an embodiment of the present disclosure will be described, with reference to the drawings. The constituent elements indicated by the same reference numerals in the drawings mean the same constituent elements. However, unless otherwise specified in the specification, each constituent element is not limited to one, and a plurality of each constituent element may be present.

Further, description of overlapping configurations and reference numerals in the respective drawings may be omitted. It should be noted that the present disclosure is not limited to the embodiments below, and can be implemented with appropriate modifications, such as omitting a configuration or replacing a configuration with a different configuration within the scope of the object of the present disclosure.

In each drawing, directions indicated by arrows X and Y are directions along the horizontal plane and are orthogonal to each other. Further, the direction indicated by the arrow Z is a direction along the perpendicular direction (vertical direction). The directions indicated by the arrows X, Y, and Z in respective figures match each other.

### <Liquid Container>

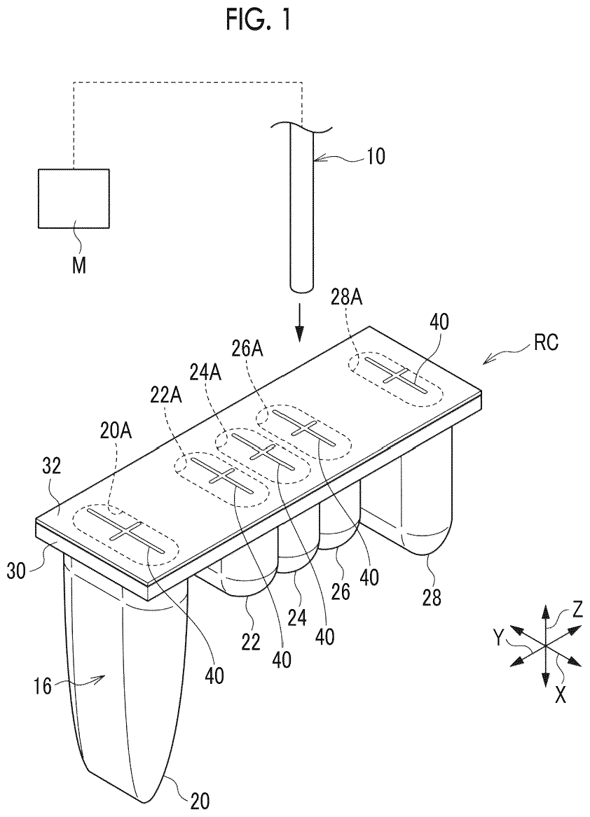

FIG. 1 shows a cartridge RC as an example of the liquid container according to the embodiment of the present disclosure. The cartridge RC is, for example, the liquid container loaded into an immunological analysis apparatus. In the immunological analysis apparatus, for example, a detecting process of labeling a substance to be detected in a specimen such as blood collected from a living body and detecting light from the label is executed.

The cartridge RC accommodates a liquid for executing the detecting process. Examples of the liquid accommodated in the cartridge RC include a buffer solution which is mixed with a specimen, a labeling reagent including a label modified with a binding substance that specifically binds to a target substance in the specimen, and a luminescent reagent for causing the label to emit light.

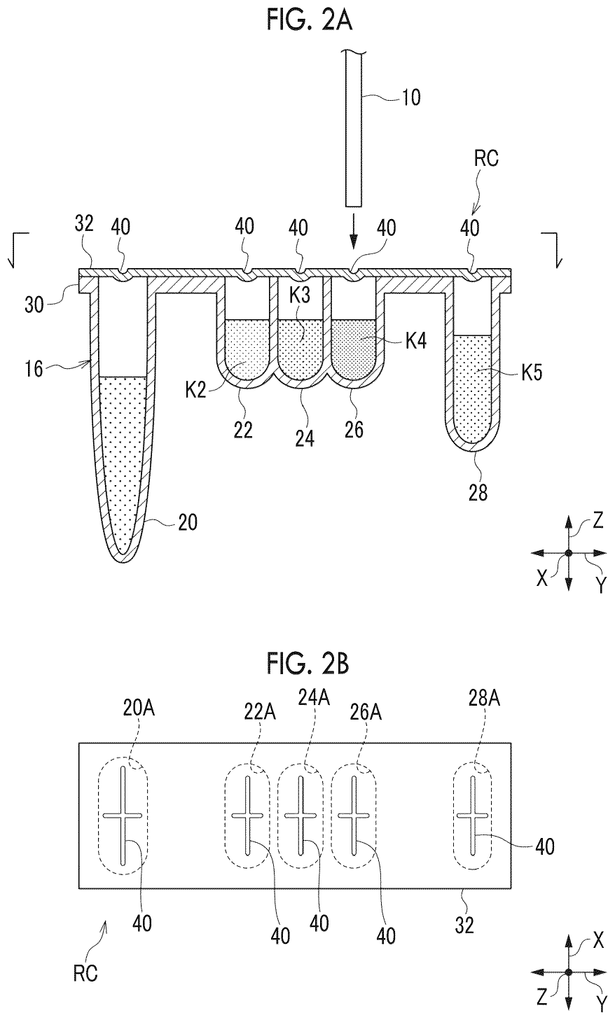

As shown in FIG. 2A, the cartridge RC includes a container body 16 and a sealing film 32. The container body 16 is provided with a plurality of accommodating portions 20, 22, 24, 26, and 28 that accommodate liquids such as the specimen, the buffer solution, and the reagent. Each of the accommodating portions 20, 22, 24, 26, and 28 has a well shape, and an opening portion 20A, 22A, 24A, 26A, or 28A is formed in an upper end portion of each of the accommodating portions 20, 22, 24, 26, and 28. The container body 16 is, for example, a plastic molded product, and integrally forms a plurality of accommodating portions 20, 22, 24, 26, and 28. A plate-like top board portion 30 is formed on an upper end side of the container body 16, and the top board portion 30 also functions as a connecting portion that connects the respective accommodating portions 20, 22, 24, 26, and 28.

As shown in FIG. 2B, the planar shapes (shape in a case where the container body 16 is plan-viewed from an upper side) of the opening portions 20A, 22A, 24A, 26A, and 28A are, for example, an elongated circular shapes. The opening portions 20A, 22A, 24A, 26A, and 28A are disposed in parallel with each other in an attitude in which the longitudinal directions of the respective elongated circular shapes are parallel to each other along the longitudinal direction (Y direction) of the cartridge RC.

The planar shape of the top board portion 30 is a rectangular shape. One sealing film 32 is attached to an upper surface of the top board portion 30. The sealing film 32 has a shape and a size conforming to the outer shape of the top board portion 30. In a case where the sealing film 32 is attached to the upper surface of the top board portion 30 in such a manner, the sealing film 32 seals the opening portions 20A, 22A, 24A, 26A, and 28A. The sealing film 32 is made of an aluminum film material and can be perforated by being pierced by a rod-shaped member such as the perforating tool 10.

For example, the perforating tool 10 is a nozzle having a function of suctioning and discharging the liquid accommodated in each of the accommodating portions 20, 22, 24, 26, and 28 of the cartridge RC. The perforating tool 10 is provided in a dispensing mechanism provided in the above-mentioned immunological analysis apparatus (not shown in the drawing).

The drive unit M is a drive unit of the dispensing mechanism. The drive unit M moves the perforating tool 10 in the up-down direction by a predetermined stroke in the immunological analysis apparatus. Thereby, the drive unit M inserts the perforating tool 10 into each of the accommodating portions 20, 22, 24, 26, and 28 of the cartridge RC loaded into the immunological analysis apparatus, or pulls out the perforating tool 10 from each of the accommodating portions 20, 22, 24, 26, and 28. Since the perforating tool 10 according to the present example also has a function of the nozzle, the perforating tool 10 suctions and discharges the liquid in each of the accommodating portions 20, 22, 24, 26, and 28.

As shown in FIG. 2A, in the cartridge RC of the present example, among the five accommodating portions 20, 22, 24, 26, and 28, the boundaries of the three accommodating portions 22, 24, and 26 disposed at the center are in contact with each other, and the wall portions of the adjacent accommodating portions are shared. The accommodating portion 20 and the accommodating portion 28 are respectively disposed on both sides of the three accommodating portions 22, 24, and 26. Each of the boundaries of the accommodating portion 20 and the accommodating portion 28 is not in contact with each of the accommodating portion 22 and the accommodating portion 26, and the wall portions are also independent. Thereby, an interval between the accommodating portion 20 and the accommodating portion 22 and an interval between the accommodating portion 26 and the accommodating portion 28 are relatively wider than the intervals between the three accommodating portions 22, 24, and 26.

For example, the accommodating portion 20 accommodates a reagent K1, the accommodating portions 22 and 24 accommodate luminescent reagents K2 and K3, respectively, the accommodating portion 26 accommodates a labeling reagent K4, and the accommodating portion 28 accommodates a buffer solution K5.

### (Sealing Film and Pressure Indentation)

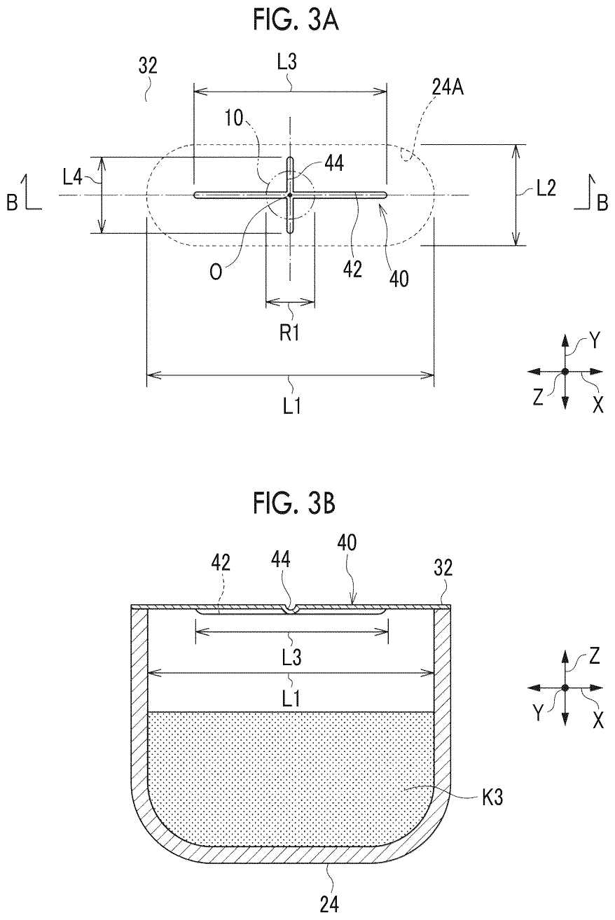

As shown in FIG. 3A, the opening portion 24A has two directions in a plan view, that is, a first direction (X direction) in which a distance L1 from an inner edge to an inner edge is relatively long and a second direction (Y direction) orthogonal to the first direction and in which a distance L2 from the inner edge to the inner edge is relatively short. In the opening portion 24A formed in an elongated circular shape, a major axis radial direction is the first direction and a minor axis radial direction is the second direction.

Further, in the sealing film 32, a pressure indentation 40 is formed on a surface at a position corresponding to the opening portion 24A. The pressure indentation 40 is linear grooves (recess portion) formed by pressing the sealing film 32 from the upper side with a jig provided with a cross-like protrusion. The depth of the pressure indentation 40 is not particularly limited, but is, for example, a depth equal to or greater than a thickness of the sealing film 32 as shown in FIG. 3B.

The pressure indentation 40 is formed of two pressure indentations 42 and 44. Among the pressure indentations 42 and 44, the pressure indentation 42 is a pressure indentation along the first direction, that is, a major axis radial direction of the opening portion 24A, and the pressure indentation 44 is a pressure indentation along the second direction, that is, a minor axis radial direction of the opening portion 24A.

A length L3 of the pressure indentation 42 is longer than a length L4 of the pressure indentation 44, is a length equal to or greater than 50% of a length (distance L1) from an inner edge to an inner edge of the opening portion 24A in the direction (X direction) in which the pressure indentation 42 extends, and is longer than a distance L2 from the inner edge to the inner edge of the opening portion 24A along the second direction. Further, the length L3 of the pressure indentation 42 has a length of 3 times or more an outer diameter R1 of the perforating tool 10.

On the other hand, the length L4 of the pressure indentation 44 is a length equal to or greater than 50% of a length (distance L2) from an end portion to an end portion of the opening portion 24A in the direction (Y direction) in which the pressure indentation 44 extends, and has a length of the outer diameter R1 or more of the perforating tool 10.

Further, the pressure indentation 42 and the pressure indentation 44 intersect with each other at a central point thereof and are orthogonal to each other. Furthermore, the pressure indentations 42 and 44 intersect with each other at the central point O of the opening portion 24A.

That is, the pressure indentation 42 is a groove that passes through the central position of the opening portion 24A in the minor axis radial direction and extends along the major axis radial direction of the opening portion 24A. Therefore, the above-mentioned distance L1 is equal to the distance between the most end portions in the major axis radial direction in the opening portion 24A having an elongated circular shape.

Further, the pressure indentation 44 is a groove that passes through the central position of the opening portion 24A in the major axis radial direction and extends along the minor axis radial direction of the opening portion 24A. Therefore, the above-mentioned distance L2 is equal to the distance between the most end portions in the minor axis radial direction in the opening portion 24A having an elongated circular shape.

As shown in FIG. 2B, the pressure indentation 40 is formed in each of the opening portions 20A, 22A, 24A, 26A, and 28A. Further, each of the pressure indentation 40 is formed of the intersection of the pressure indentations 42 and 44 at the central points of the opening portions 20A, 22A, 26A, and 28A in the same manner as in the opening portion 24A.

### Comparative Example

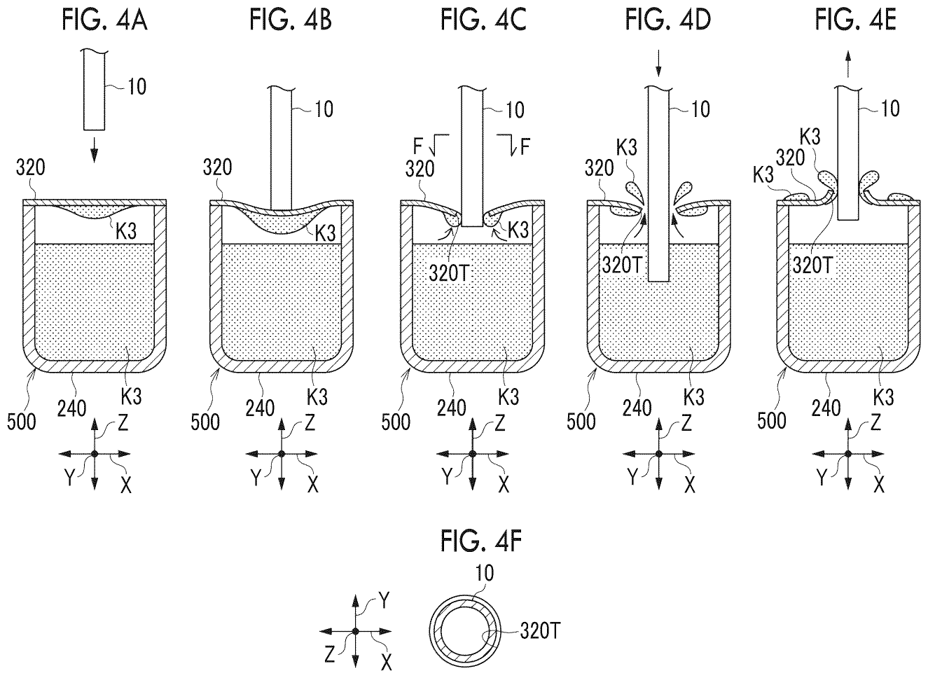

In a case where the perforating tool 10 is about to perforate a sealing film 320 of a liquid container 500 according to the “comparative example” in which the pressure indentation is not formed as shown in FIG. 4A, the front end of the perforating tool 10 presses the sealing film 320 as shown in FIG. 4B, and the perforating tool 10 is pierced into the sealing film 320 as shown in FIG. 4C. Therefore, a through-hole 320T having a diameter of a shaft portion of the perforating tool 10 is opened in the sealing film 320. The luminescent reagent K3 (hereinafter, referred to as a liquid K3) in the accommodating portion 240 is attached to the rear surface of the sealing film 320. Therefore, in a case where the through-hole 320T is opened, the liquid K3 attached to the rear surface of the sealing film 320 encircles a gap between the through-hole 320T and the perforating tool 10, and the liquid K3 enters the gap. In the liquid container 500 according to the comparative example, the pressure indentation is not formed on the sealing film 320. Therefore, the sealing film 320 is unlikely to be torn by the perforating tool 10, and a diameter of the perforating tool 10 is approximate to a diameter of the through-hole 320T. That is, a gap width between the perforating tool 10 and an inner edge of the through-hole 320T is narrow. In such a case, the liquid K3 is held so as to clog the gap.

Further, even in a case where an insertion amount of the perforating tool 10 is large, the state where the gap width is narrow does not change, and the state where the liquid K3 clogs the gap continues. On the other hand, the pressure in the accommodating portion 240 increases due to the insertion of the perforating tool 10 into the accommodating portion 240, and the air in the accommodating portion 240 is about to be ejected to the outside of the accommodating portion 240 from the gap between the through-hole 320T and the perforating tool 10. As the insertion amount of the perforating tool 10 increases, the internal pressure increases, and the pressure, at which the air in the accommodating portion 240 is about to be ejected to the outside of the accommodating portion 240 through the gap, also increases. As shown in FIG. 4D, in a case where the insertion amount of the perforating tool 10 further increases and the pressure in the accommodating portion 240 further increases, the air in the accommodating portion 240 is eventually ejected to the outside of the liquid container 500 together with the liquid K3 that clogs the gap. Due to such a mechanism, the liquid K3 held in the gap between the through-hole 320T and the perforating tool 10 may be ejected to the outside of the accommodating portion 240, and the liquid may be scattered around the through-hole 320T. Further, if the liquid container 500 is heated, the pressure is also increased due to the temperature increase. Thus, the ejection amount tends to be further increased.

Further, as shown in FIG. 4E, in a case where the perforating tool 10 is pulled out from the accommodating portion 240, the sealing film 320 may be pulled by the perforating tool 10 through a frictional force between the inner edge of the through-hole 320T and the perforating tool 10, and a state where the circumference of the through-hole 320T protrudes to the outside of the accommodating portion 240 may occur. In such a case, there is a concern that the liquid K3 attached to the rear surface of the sealing film 320 around the through-hole 320T may be ejected and scattered to the outside of the accommodating portion 240 from the through-hole 320T. In a case where the liquid K3 is scattered to the outside of the accommodating portion 240, there is a concern that an environment in which the cartridge RC (refer to FIG. 1) is disposed may be contaminated.

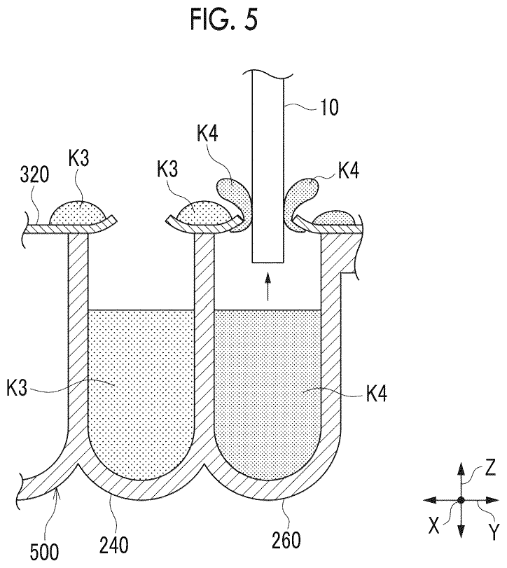

Then, in a state where the liquid K3 is scattered to the outside of the accommodating portion 240, as shown in FIG. 5, for example, in a case where the sealing film 320 covering the accommodating portion 260 adjacent to the accommodating portion 240 is perforated using the perforating tool 10, the liquid (the labeling reagent K4: hereinafter, referred to as a liquid K4) may be scattered to the outside of the accommodating portion 260 and the accommodating portion 240. Thereby, the two liquids (the liquid K3 and the liquid K4) are mixed outside the accommodating portions 240 and 260.

In a case where the two liquids are mixed in such a manner, the mixed liquid may be attached to the perforating tool 10. In a case where each of the liquids is used individually to perform the examination, another liquid is mixed into each of the liquids. Therefore, unintended contamination between liquids occurs, which may affect the examination results. Further, even in a case where each of the liquids is quantitatively mixed and the examination is performed, an error occurs in an amount of mixture, which may affect the examination results.

### Actions and Effects

On the other hand, in the cartridge RC which is an example of the liquid container according to the present disclosure, as shown in FIG. 1, the pressure indentation 40 is formed on the surface of the sealing film 32 that seals the accommodating portion 24 which accommodates the liquid.

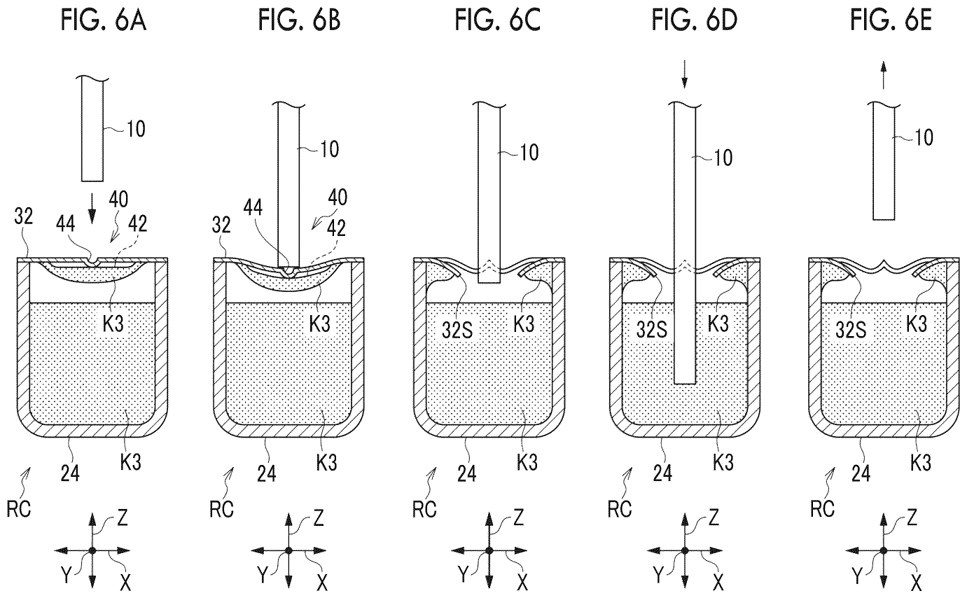

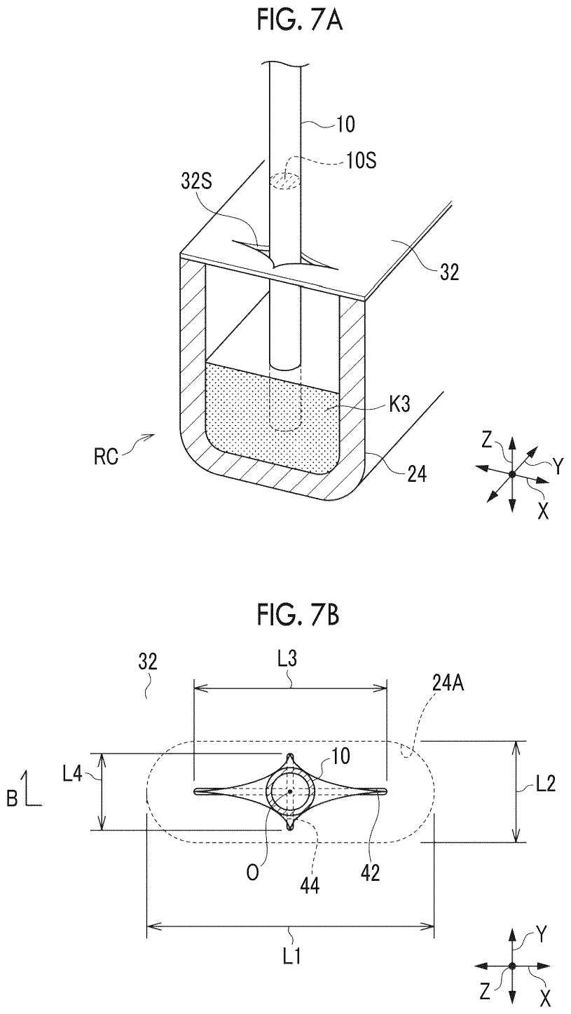

As shown in FIG. 6A, in a case where the sealing film 32 is perforated using the perforating tool 10. As shown in FIG. 6B, the front end of the perforating tool 10 presses the sealing film 32. As shown in FIG. 6C, the perforating tool 10 is pierced into the sealing film 32. Therefore, a through-hole 32S is opened in the sealing film 32. Specifically, as shown in FIG. 7A, the sealing film 32 is perforated by the perforating tool 10 to form the through-hole 32S in the sealing film 32. An area of the through-hole 32S is greater than an area of a traverse cross section 10S of the perforating tool 10.

The reason for this is as follows. In the pressure indentation 40, in a case where the perforating tool 10 is pressed against the intersection of the pressure indentations 42 and 44 to perforate the sealing film 32, as shown in FIG. 7B, the part of the sealing film 32 in which the pressure indentations 42 and 44 are formed is likely to be torn. Then, gaps are formed in regions surrounded by the perforating tool 10 and both sides of the pressure indentations 42 and 44.

Here, the length L3 of the pressure indentation 42 is a length equal to or greater than 50% of a length (distance L1) from an inner edge to an inner edge of the opening portion 24A in a direction in which the pressure indentation 42 extends. That is, in a case where the perforating tool 10 is pressed against the sealing film 32 at the pressure indentation 42 to perforate the sealing film 32 and tear the pressure indentation, a part extending over a length equal to or greater than 50% of the distance L1 is likely to be torn. Therefore, a large gap is formed between the perforating tool 10 and the inner edge of the through-hole 32S, as compared with a case where the length of the pressure indentation 42 is less than 50% of the distance L1.

Similarly, the length L4 of the pressure indentation 44 is a length equal to or greater than 50% of the length (distance L2) from the inner edge to the inner edge of the opening portion 24A in a direction in which the pressure indentation 44 extends. That is, in a case where the perforating tool 10 is pressed against the pressure indentation 44 to perforate the sealing film 32 and tear the pressure indentation, a part extending over a length equal to or greater than 50% of the distance L2 is likely to be torn. Therefore, a large gap is formed between the perforating tool 10 and the inner edge of the through-hole 32S, as compared with a case where the length of the pressure indentation 44 is less than 50% of the distance L2.

As described above, in the cartridge RC, the pressure indentation 42 and the pressure indentation 44 are formed. Thus, a large diameter through-hole can be formed as compared with the liquid container 500 not provided with the pressure indentation. Therefore, even in a case where the liquid K3 is attached to the rear side of the sealing film 32 around the through-hole 32S, it is difficult for the liquid K3 attached to the rear surface of the sealing film 32 to enter the gap between the perforating tool 10 and the inner edge of the through-hole 32S, and the liquid K3 is unlikely to enter the gap. Therefore, the liquid K3 is unlikely to be held to clog the gap.

Further, as shown in FIG. 6D, even in a case where the perforating tool 10 is pushed into the accommodating portion 24, the gap between the perforating tool 10 and the inner edge of the through-hole 32S is maintained, and the passage of air is consistently ensured. Therefore, the liquid K3 is suppressed from being ejected to the outside of the accommodating portion 24.

Further, as shown in FIG. 6E, even in a case where the perforating tool 10 is pulled out from the accommodating portion 24, the inner edge of the through-hole 32S and the perforating tool 10 are unlikely to come into contact with each other. Therefore, the liquid K3 attached to the rear surface of the sealing film 32 around the through-hole 32S is unlikely to be ejected to the outside of the accommodating portion 24.

In such a manner, the pressure indentation 40 is formed. Therefore, even if the liquid is attached to the rear surface of the sealing film 32, scattering of the liquid to the outside of the accommodating portion 24 can be suppressed in a case where the sealing film 32 that seals the opening portion 24A of the accommodating portion 24 which accommodates the liquid is perforated.

As described above, the pressure indentation 40 is the linear grooves formed by pressing the sealing film 32 from the upper side by the jig provided with the cross-like protrusion. As a method of forming the grooves on the surface of the sealing film 32, a method of scraping the sealing film 32 to reduce the thickness thereof can also be considered. Regarding such grooves, the sealing film is likely to be torn along the grooves as compared with the pressure indentation. However, the grooves are also likely to be torn in a case where an external force is unexpectedly applied to the cartridge RC and the accommodating portion 24 is deformed. Therefore, the sealing performance of the liquid is deteriorated. In the present disclosure, since the grooves are formed by the pressure indentation 40, it is easy to ensure the sealing performance. Thus, the pressure indentation 40 is suitable for sealing a chemical substance, a specimen, or the like that is not preferable to be leaked to the outside.

Further, as shown in FIG. 3A, the cartridge RC according to the present disclosure has two directions including the first direction (X direction) in which the distance from the inner edge to the inner edge of the opening portion 24A is relatively long and the second direction (Y direction) in which the distance is relatively short. Furthermore, the first direction and the second direction are orthogonal to each other. Then, the length L3 of the pressure indentation 42 is longer than the distance L2 from the inner edge to the inner edge along the second direction of the opening portion 24A.

The outer diameter R1 of the perforating tool 10 that can be inserted into the accommodating portion 24 is less than the distance L2 from the inner edge to the inner edge along the second direction of the opening portion 24A. Therefore, the length L3 of the pressure indentation 42 is longer than the outer diameter R1 of the perforating tool 10 that can be inserted into the accommodating portion 24.

Therefore, in a case where the perforating tool 10 is pressed against the pressure indentation 42 to perforate the sealing film 32, a part where the pressure indentation having a length longer than the outer diameter R1 of the perforating tool 10 is formed is torn, and the gap is likely to be formed.

Thereby, it is easy to form a large gap as compared with a case of forming only the pressure indentation shorter than the distance L2 along the second direction of the opening portion 24A. Therefore, it is possible to more reliably suppress the scattering of the liquid to the outside of the cartridge RC.

It should be noted that in the cartridge RC according to the present disclosure, the length L3 of the pressure indentation 42 has a length of three times or more the outer diameter R1 of the perforating tool 10. Therefore, in a case where the perforating tool 10 is pressed against the pressure indentation 42 to perforate the sealing film 32, a part where the pressure indentation having a length longer than three times the outer diameter R1 of the perforating tool 10 is formed is torn, and the gap is likely to be formed.

Further, in the cartridge RC according to the present disclosure, two pressure indentations are formed (that is, the two pressure indentations 42 and 44 are formed), and the two pressure indentations intersect with each other at the central points thereof. Thereby, as shown in FIG. 7B, in a case where the perforating tool 10 is pressed against the intersection of the two pressure indentations 42 and 44 to perforate the sealing film 32, the sealing film 32 is torn from the central point of the pressure indentations 42 and 44 toward the end portions. Therefore, for example, the sealing film 32 is torn at a higher speed, as compared with a case where the sealing film 32 is torn from one end portion to the other end portion of the pressure indentation 42. Therefore, a gap can be quickly formed in each of the regions surrounded by the perforating tool 10 and the inner edges of the sealing films 32 on both sides of the pressure indentations 42 and 44.

Further, in a case where the perforating tool 10 is pressed against the sealing film 32, the pressing force is converted into a tearing force for each pressure indentation. In the cartridge RC according to the present disclosure, since the number of pressure indentations is two, the tearing force acting on one pressure indentation from the perforating tool 10 is greater than that in a case where the number of pressure indentations is three or more. Therefore, the pressure indentation is torn and the gap is likely to be formed.

Further, in the cartridge RC according to the present disclosure, as shown in FIG. 3A, the pressure indentations 42 and 44 intersect with each other at the central point O of the opening portion 24A. Therefore, as shown in FIG. 7B, in a case where the sealing film 32 is perforated by pressing the perforating tool 10 against the intersection of the two pressure indentations 42 and 44, the gap centered on the central point O of the opening portion 24A is likely to be formed. That is, disposition of the gap formed on the rear surface of the sealing film 32 is less biased. Thereby, even in a case where the liquid is biased and is attached to the rear surface of the sealing film 32, the gas inside the accommodating portion 24 is able to easily pass to the outside of the accommodating portion 24 from the gap on the side to which the liquid is not attached, and it is easy to suppress the scattering of the liquid to the outside of the cartridge RC.

Further, in the cartridge RC according to the present disclosure, the pressure indentations 42 and 44 are orthogonal to each other. Therefore, as shown in FIG. 7B, in a case where the sealing film 32 is perforated by pressing the perforating tool 10 against the intersection of the two pressure indentations 42 and 44, gaps are likely to be formed around the perforating tool 10 at every 90 degrees in a circumferential direction around the intersection of the pressure indentations 42 and 44 as a center. That is, disposition of the gap formed on the rear surface of the sealing film 32 is less biased. Thereby, even in a case where the liquid is biased and is attached to the rear surface of the sealing film 32, the gas inside the accommodating portion 24 is able to easily pass to the outside of the accommodating portion 24 from the gaps on the sides to which the liquid is not attached, and it is easy to suppress the scattering of the liquid to the outside of the accommodating portion 24.

In the cartridge RC according to the present disclosure, as shown in FIG. 2B, the planar shapes of the opening portions 20A, 22A, 24A, 26B, and 28A are elongated circular shapes. As in the pressure indentation 42 shown in FIG. 3A, by forming the pressure indentation along the major axis of the elongated circular shape, the length of the pressure indentation can be increased.

Further, the cartridge RC according to the present disclosure has a plurality of accommodating portions, and opening portions of the accommodating portions are arranged side by side. That is, as shown in FIG. 2B, the opening portions 20A, 22A, 24A, 26B, and 28A are disposed in a row.

In a case where the opening portions of the plurality of accommodating portions are arranged side by side, the liquids sealed in the accommodating portions may be ejected to the outside of the liquid container. For example, as shown in the comparative example of FIG. 5, the liquid (liquid K3) sealed in the accommodating portions 240 and the liquid (liquid K4) accommodated in the accommodating portions 260 may be scattered to the outside of the cartridge RC. In such a case, the liquids may be mixed outside the cartridge RC.

For example, in a case where a nozzle that suctions and discharges the liquid is used as the perforating tool 10 and the liquid (liquid K4) suctioned into the accommodating portion 260 is discharged to the outside of the accommodating portion 260 to be used, the liquids (liquid K3 and liquid K4) may be mixed outside the cartridge RC. In such a case, there is a concern that the mixed liquids (liquid K3 and liquid K4) may be attached to the nozzle. In a case where the mixed liquid is attached to the nozzle and the examination or the like is performed using each liquid individually, another liquid is mixed into each liquid. Further, in a case where each of the liquids is quantitatively mixed and used, an error occurs in an amount of mixture thereof.

In the cartridge RC according to the present disclosure, since scattering of the liquid to the outside of the cartridge RC can be suppressed, there is less concern that the liquid may be mixed outside the cartridge RC.

Further, in the cartridge RC according to the present disclosure, the pressure indentation 40 is provided in each of the opening portions 20A, 22A, 24A, 26B, and 28A. That is, it is possible to suppress the scattering of each liquid accommodated in each of the accommodating portions 20, 22, 24, 26, and 28 to the outside of the cartridge RC. Thereby, it is possible to reduce the concern that the liquid may be mixed outside the cartridge RC as compared with a case where the pressure indentation 40 is provided only in a specific opening portion.

In the cartridge RC according to the present disclosure, the sealing film 32 is made of aluminum. Therefore, the elastic modulus is greater than that of an elastomer or the like. Since the sealing film having a large elastic modulus is not easily deformed, only the part through which the perforating tool 10 passes is not easily deformed to be torn, and the circumference of the part through which the perforating tool 10 passes is also torn. Therefore, an opening area through which the perforating tool 10 passes is ensured. Therefore, an area of the gap is likely to be larger than that in a case where the sealing film having a small elastic modulus is used. Therefore, it is easy to suppress the scattering of the liquid to the outside of the cartridge RC.

On the other hand, in a case where the perforating tool 10 perforates the sealing film formed of a material having a small elastic modulus, such as an elastomer, the sealing film, which is cut and torn by the perforating tool 10, is deformed along the outer circumferential portion of the perforating tool 10. That is, since the sealing film can be easily deformed, only the part through which the perforating tool 10 passes is torn and deformed, and the sealing film around the part through which the perforating tool 10 passes is unlikely to be torn. In such a case, the outer diameter of the perforating tool 10 and the inner diameter of the through-hole formed by perforating the sealing film with the perforating tool 10 substantially match each other. That is, a gap width between the perforating tool 10 and the through-hole is narrow. In such a case, the gap is likely to be filled with the liquid. In a case where the gas inside the cartridge RC is ejected, the liquid filled in the gap is pushed out to the gas and is likely to be scattered to the outside of the cartridge RC.

### Modification Example

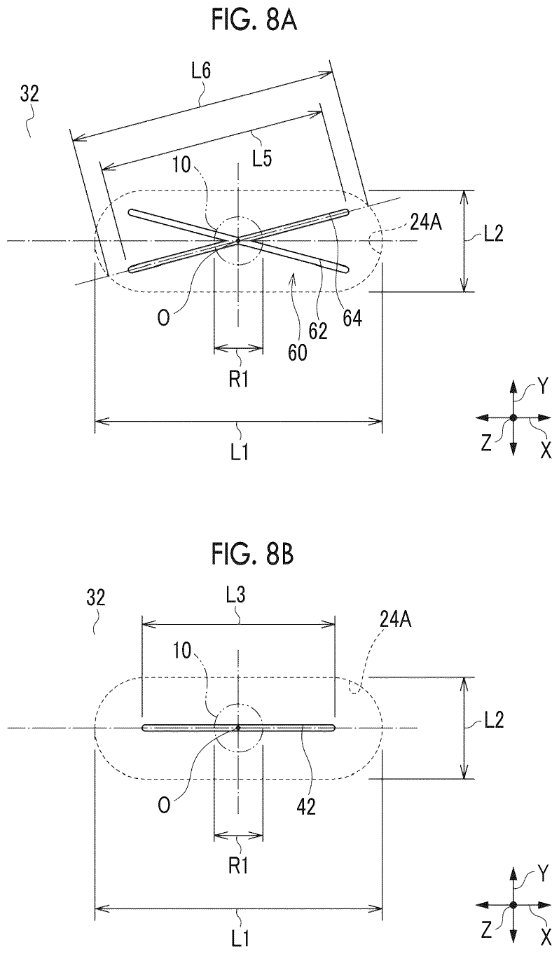

In the cartridge RC according to the present disclosure, as shown in FIG. 3A, two pressure indentations 42 and 44 are formed to be orthogonal to each other, but the embodiment of the present disclosure is not limited thereto. For example, as in pressure indentations 62 and 64 that form a pressure indentation 60 shown in FIG. 8A, the pressure indentations 62 and 64 may not be orthogonal to each other as long as the pressure indentations 62 and 64 intersect with each other. Lengths of the pressure indentations 62 and 64 in this example are equal to each other (length L5). Further, the length L5 is a length equal to or greater than 50% of a length L6 from the inner edge to the inner edge of the opening portion 24A in each of the directions in which the pressure indentations 62 and 64 extend.

In a case where the two pressure indentations intersect with each other at an angle other than a right angle, the lengths of the two pressure indentations may be different from each other. In the two pressure indentations, at least one pressure indentation may have a length equal to or greater than 50% of a length from the inner edge to the inner edge of the opening portion 24A in the direction in which the pressure indentation extends.

Further, in the cartridge RC, as shown in FIG. 3A, two pressure indentations 42 and 44 intersect with each other at the central point thereof, but the embodiment of the present disclosure is not limited thereto. That is, in a case where there are two pressure indentations, the pressure indentations may intersect with each other at any part as long as the pressure indentations intersect with each other.

Further, in the cartridge RC, as shown in FIG. 3A, the two pressure indentations 42 and 44 intersect with each other at the central point O of the opening portion 24A, but the embodiment of the present disclosure is not limited thereto. That is, in a case where there are two pressure indentations, the pressure indentations may intersect with each other at any position in the opening portion 24A as long as the pressure indentations intersect with each other.

Further, in the cartridge RC, as shown in FIG. 3A, the length L3 of the pressure indentation 42 is a length equal to or greater than 50% of a length from the inner edge to the inner edge of the opening portion 24A in the direction (X direction) in which the pressure indentation 42 extends (that is, the distance L1), and the length L4 of the pressure indentation 44 is a length equal to or greater than 50% of a length from the end portion to the end portion of the opening portion 24A in the direction (Y direction) in which the pressure indentation 44 extends (that is, the distance L2). However, the embodiment of the present disclosure is not limited thereto.

Specifically, the length L4 of the pressure indentation 44 is not limited as long as the length L3 of the pressure indentation 42 is a length equal to or greater than 50% of the distance L1. Further, as shown in FIG. 8B, the pressure indentation 44 may be omitted in a case where the pressure indentation 42 is formed. That is, it is sufficient that there is at least one pressure indentation. Even in a case where there is one pressure indentation, the length L3 may be a length equal to or greater than 50% of the distance L1. In such a case, the scattering of the liquid to the outside of the cartridge RC can be suppressed.

Further, in a case where there are a plurality of pressure indentation, the number of the plurality of pressure indentations may be three or more as long as the plurality of pressure indentations intersect with each other at one intersection.

Further, in the cartridge RC, the pressure indentation 40 is provided in each of the opening portions 20A, 22A, 24A, 26B, and 28A, but the embodiment of the present disclosure is not limited thereto. The pressure indentation may be formed in any of the opening portions 20A, 22A, 24A, 26B, and 28A.

Further, the cartridge RC includes the plurality of accommodating portions 20, 22, 24, 26, and 28. The opening portions 20A, 22A, 24A, 26B, and 28A of the accommodating portions are arranged side by side. However, the embodiment of the present disclosure is not limited thereto. For example, it is not necessary for the accommodating portions and opening portions to be arranged side by side. Further, the number of the accommodating portions is not particularly limited, and may be one.

Further, in the cartridge RC, the planar shapes of the opening portions 20A, 22A, 24A, 26A, and 28A are elongated circular shapes, but the embodiment of the present disclosure is not limited thereto. The shape of the opening portion may be a perfect circle or an ellipse, a quadrangle such as a square or a rectangle, or a polygon other than the quadrangle.

The present disclosure is not limited to the above-mentioned embodiments, and can be implemented with appropriate modifications, such as omitting a configuration or replacing a configuration with a different configuration within the scope that does not deviate from the gist of the present disclosure.

The disclosure of JP2022-045777 filed on Mar. 22, 2022 is incorporated herein by reference in its entirety.

All documents, patent applications, and technical standards described in the present specification are incorporated into the present specification by reference to the same extent as in a case where the individual documents, patent applications, and technical standards were specifically and individually stated to be incorporated by reference.

What is claimed is:

1. A liquid container comprising:
an accommodating portion that accommodates a liquid and has an opening portion at an upper end thereof,
a sealing film that seals the opening portion and that is capable of being perforated by being pierced by a perforating tool; and
at least one pressure indentation that is linear and is formed on a surface of the sealing film,
wherein a length of the at least one pressure indentation is a length equal to or greater than 50% of a length from an end portion to an end portion of the opening portion in a direction in which the pressure indentation extends.

2. The liquid container according to claim 1,
wherein the opening portion has, in a plan view, two directions of a first direction in which a distance between inner edges is relatively long and a second direction which is orthogonal to the first direction and in which the distance is relatively short, and
the length of the at least one pressure indentation is longer than the distance along the second direction of the opening portion.

3. The liquid container according to claim 1,
wherein a plurality of the pressure indentations are formed and intersect with each other at one intersection.

4. The liquid container according to claim 3,
wherein two of the pressure indentations are formed to intersect with each other at a central point of the pressure indentations.

5. The liquid container according to claim 4,
wherein the pressure indentations intersect with each other at a central point of the opening portion.

6. The liquid container according to claim 4,
wherein the pressure indentations are orthogonal to each other.

7. The liquid container according to claim 1,
wherein a planar shape of the opening portion is an elongated circular shape.

8. The liquid container according to claim 1,
wherein a plurality of the accommodating portions are provided, and the opening portions of the accommodating portions are arranged side by side.

9. The liquid container according to claim 8,
wherein the pressure indentation is provided in each of the opening portions.

10. The liquid container according to claim 1,
wherein the sealing film is made of aluminum.
